(19) United States
(12) Patent Application Publication
(10) Pub. No.: US 2014/0130878 A1
(43) Pub. Date: May 15, 2014

(54) INTELLIGENT VALVE NETWORK

(71) Applicant: Luis Marinez, Houston, TX (US)

(72) Inventor: Luis Marinez, Houston, TX (US)

(21) Appl. No.: 14/052,508

(22) Filed: Oct. 11, 2013

Related U.S. Application Data
(60) Provisional application No. 61/712,696, filed on Oct. 11, 2012.

(51) Int. Cl. G05D 7/06

(52) U.S. Cl. CPC G05D 7/0617
USPC 137/2; 137/487.5

(57) ABSTRACT

The present invention includes a valve for connecting to a valve network comprising: at least one valve assemble, having at least one valve to control a fluid or gas flow through an opening in the valve assembly; at least one pressure sensor; viscosity sensor; flow rate detector; and temperature sensor; at least one processor connected to each of the valve and sensors, wherein the processor is capable of controlling the position of the valve based on the information obtained from the sensors; at least one communications module connected to the processor capable of transmitting to and receiving information from the valve network and capable of sending information obtained from the valve assembly to the valve network of the status of the fluid or gas flowing through the valve assembly; and at least one power source that provides power to the valve assembly.

### CROSS-REFERENCE TO RELATED APPLICATIONS

This application claims priority to U.S. Provisional Application Ser. No. 61/712,696, filed Oct. 11, 2012, the entire contents of which are incorporated herein by reference.

### TECHNICAL FIELD OF THE INVENTION

The present invention relates in general to the field of delivery of fluids via pipelines, and more particularly, to an intelligent valve network that controls all aspects of fluid flow within a pipeline including preprogrammed control routines and intelligent control decisions via software and hardware.

### STATEMENT OF FEDERALLY FUNDED RESEARCH

None.

### BACKGROUND OF THE INVENTION

Without limiting the scope of the invention, its background is described in connection with valve control.

One such system is taught in U.S. Pat. No. 8,127,783, issued to Balarabe, et al., which teaches a method for preventing a mass flow controller from participating in cross-talk in an array of mass flow controllers. The method includes sensing and providing a signal indicative of a fluid pressure inside a mass flow controller, determining a response of the control valve to a rapid pressure fluctuation as the inlet of the mass flow controller using a signal indicative of fluid pressure to avoid overcompensation to the rapid pressure fluctuation, and adjusting a control valve contained within the mass flow controller downstream from the pressure sensor, based on a predetermined response, so that the mass flow controller avoids overcompensating for the rapid pressure fluctuation.

Another such system is taught in U.S. Pat. No. 7,004,191, issued to Shajii, et al., which is directed to a mass flow controller that provides a webserver that allows access to the web server through interworking networks such as the Internet.

Another patent is U.S. Pat. No. 5,558,115, issued to Lenz, et al., which is directed to a valve positioner that receives a set-point from a master and provide control pressure to a valve actuator to control the valve. A sensing circuit in the positioner is said to sense the position of the valve and the control pressure, and a control circuit in the positioner uses both the sensed pressure and position to provide a command output to a pneumatic section that produces the control pressure.

Another patent is U.S. Pat. No. 4,672,997, issued to Landis and Fabricius, this is directed to a modular, self-diagnostic mass-flow controller and system that includes separable and interchangeable housings to provide mass-flow controller component repair and replacement without further system disconnection. The system includes dual sensors and electronics to control mass flow and provide self-diagnostics to ensure that the controller is operating properly.

Despite numerous developments around process automation in a valve (aperture and closure of liquid or gas flow) widespread problems continue with pipelines of oil and its derivatives, including explosions, spills of products (in the case of oil and gasoline) and many problems affecting the environment and generate huge losses to companies.

Vandalism is another problem associated with large pipelines, which is very common in all countries. Vandalism often causes great environmental damage around pipelines and also leads to losses from lack of productivity and increased operational costs. Furthermore, thieves often penetrate the pipelines, stealing the product (oil, diesel or gasoline) and for the pressure and/or volume, and injected water to hide the loss in flow. Presently, there is no way to determine in these conditions when the product is being lost.

Another problem in the operation of pipelines is the lack of process automation in the energy field. Advances in automatic valves opening and closing are currently dependent on the power supply, which is supplied by electricity interconnection lines that travel from town to town and this energy resource is used to automate processes with these lines provided the conduct of petroleum or petroleum products are near the electrical system.

Current processes for automating oil pipelines include limitations from the power supply for mechanically opening and closing the valves, as these often requires a lot of horsepower to close the flow of material (oil, gasoline) in the mechanism such as disk valves, ball valves, butterfly valves, slips valves, or any other system. On the other hand, the process for transmitting of data and operation mechanisms are similarly limited due to poor coverage in some areas where remote GPRS signals are transmitted through the pipelines.

### SUMMARY OF THE INVENTION

In one embodiment, the present invention includes a valve for connecting to a valve network comprising: at least one valve assembly, the valve assembly comprising: at least one valve to control a fluid or gas flow through an opening in the valve assembly; at least one pressure sensor to detect the pressure of the fluid or gas in the valve assembly; at least one viscosity sensor to detect the viscosity of the fluid or gas in the valve assembly; at least one flow rate detector to detect at least one of the flow or the volume of the fluid or gas flowing through the valve assembly; at least one temperature sensor to detect the temperature of the fluid or gas in the valve assembly; at least electrical power generator that generates electrical power from fluid flowing through the valve; at least one processor connected the valve, the pressure sensor, the flow rate detector, the viscosity sensor and the temperature sensor, wherein the processor is capable of controlling the position of the valve based on the information obtained from the pressure sensor, the flow rate detector, the viscosity sensor and the temperature sensor; at least one communications module connected to the processor capable of transmitting to and receiving information from at least one of other valves in the valve network or a control unit; at least one security module mounted on the valve and connected to the communications module and the processor, wherein the security module is capable of sending information obtained from the valve assembly to the valve network of the status of the fluid or gas flowing through the valve assembly; and at least one power source that provides power to the valve assembly, processor and communication module, and the security module and is charged and/or recharged by the electrical power generator. In one aspect, the communication modules use at least one of cellular network, satellite network, UMTS network, 2G network, 3G network, GSM network, CDMA network, WCDMA network, GPRS network, iBurst network, WiBro network, WiMAX network, UMTS-TDD network, HSPA network, EVDO network, LTE network, personal area network (PAN), Bluetooth network, ZigBee network, Wireless USB network, or Digital Enhanced Cordless Telecommunications (DECT) network to communicate within the valve network. In another aspect, the power source is selected from at least one of a battery, a fuel cell, a power generator, a nuclear power cell, a solar panel, and an electrically connected line across the valve network. In another aspect, a secondary communication system is connected to the valve is selected from communication line, a fiber optic line, an intranet, a satellite, a telephone system, and an intranet and has a separate, redundant power supply. In another aspect, at least one of the communications module of the valve network is capable of communication with at least one of a remote land-based location or an offshore surface location. In another aspect, the invention further comprises a control unit that comprises a secure satellite communications module, a valve control processor, a processor with preconfigured parameters for operating the valve if communications are lost with the valve and one or more webservers that can control additional valves of the valve network. In another aspect, the valve is actuated magnetically, electromagnetically, mechanically, electrically, electromechanically, hydraulically, or pneumatically. In another aspect, the security modules comprises one or more cameras, motion sensors, or IR sensors, that send information about the physical status of the valve to the valve network. In another aspect, the electrical power generator is selected from a solar power cell, an electrical generator, a dynamo, a nuclear power cell, or an alternator. In another aspect, the electrical power generator is selected from an electrical generator, a dynamo, or an alternator that transforms kinetic energy into electricity wherein the generator, dynamo or alternator is driven by an impeller, propeller, screw-drive, paddle, or turbine positioned parallel to a fluid flow axis of the valve.

Yet another embodiment of the present invention includes a method for use in a pipeline, comprising:

providing two or more valves in a valve network, each valve of the valve network comprising: at least one valve to control a fluid or gas flow through an opening in the valve assembly, the valve having an open, a partially open and a closed position; at least one pressure sensor to detect the pressure of the fluid or gas in the valve assembly; at least one viscosity sensor to detect the viscosity of the fluid or gas in the valve assembly; at least one flow rate detector to detect at least one of the flow or the volume of the fluid or gas flowing through the valve assembly; at least one temperature sensor to detect the temperature of the fluid or gas in the valve assembly; at least electrical power generator that generates electrical power from fluid flowing through the valve; at least one processor connected to each of the valves, the pressure sensor, the flow rate detector, the viscosity sensor and the temperature sensor, wherein the processor is capable of controlling the position of the valve based on the information obtained from the pressure sensor, the flow rate detector, the viscosity sensor and the temperature sensor; at least one communications module connected to the processor capable of transmitting to and receiving information from at least one of other valves in the valve network or a control unit; at least one security module mounted on the valve and connected to the communications module and the processor, wherein the security module is capable of sending information obtained from the valve assembly to the valve network of the status of the fluid or gas flowing through the valve assembly; and at least one power source that provides power to the valve assembly, processor and communication module, and the security module and is charged and/or recharged by the electrical power generator; and electronically interconnecting the two or more valves into the valve network in which each of the valves operates, wherein each valve communicates operational data obtained from the pressure sensor, the flow rate detector, the viscosity sensor and the temperature sensor, and the position of the valve to the valve network via the communications module; wherein the valve assemblies synchronize opening, partially opening and closing of each valves depending on one or more parameters that relate to a fluid flow through each of the valves in the valve network. In one aspect, the method further comprises the step of sharing data across valves or across valves of a pipeline using a wireless network device. In one aspect, the method further comprises the step of storing information in a memory module connected to the processor and transferring the stored information via the valve network. In one aspect, the method further comprises the step of determining if a security breach has occurred along the pipeline by comparing one or more data points obtained from the pressure sensor, the flow rate detector, the viscosity sensor and the temperature sensor, and the position of the valve. In another aspect, the valve is open and closed using the wireless network device. In another aspect, the communications module operates over a wireless network. In another aspect, the communication modules use at least one of GPRS, GSM, RF, WiFi, Ethernet, Zig Bee, or Bluetooth, to communicate within the valve network. In another aspect, the power source is selected from at least one of a battery, a fuel cell, a power generator, a nuclear power cell, a solar panel, and an electrically connected line across the valve network. In another aspect, a secondary communication system is connected to the valve is selected from communication line, a fiber optic line, an intranet, a satellite, a telephone system, and an intranet. In another aspect, the at least one of the communications module of the valve network is capable of communication with a remote land-based location and an offshore surface location. In another aspect, the method further comprises a control unit that comprises a secure satellite communications module, a valve control processor, a processor with preconfigured parameters for operating the valve if communications are lost with the valve and one or more webservers that can control additional valves of the valve network. In another aspect, the valve is actuated magnetically, electromagnetically, mechanically, electrically, electromechanically, hydraulically, or pneumatically. In another aspect, the security modules comprises one or more cameras, motion sensors, or IR sensors, that send information about the physical status of the valve to the valve network. In another aspect, the electrical power generator is selected from a solar power cell, an electrical generator, a dynamo, a nuclear power cell, or an alternator. In another aspect, the electrical power generator is selected from an electrical generator, a dynamo, or an alternator that transforms kinetic energy into electricity wherein the generator, dynamo or alternator is driven by an impeller, propeller, screw-drive, paddle, or turbine positioned parallel to a fluid flow axis of the valve.

Yet another embodiment of the present invention includes a system for interconnecting a valve network on a pipeline, comprising: a first valve assembly positioned at a first position of the pipeline; a second valve assembly positioned at a second position of the pipeline; a central control unit in communication with the first and second valve assemblies, wherein first and second valve assemblies transfer data between the first valve assembly and the second valve assembly using short-range wireless communication operating without the need for a central network. In another aspect, the first and second valve assemblies comprise: two or more valve assemblies, the valve assembly comprising: at least one valve sensor to control a fluid or gas flow through an opening in the valve assembly; at least one pressure sensor to detect the pressure of the fluid or gas in the valve assembly; at least one viscosity sensor to detect the viscosity of the fluid or gas in the valve assembly; at least one flow rate detector to detect at least one of the flow or the volume of the fluid or gas flowing through the valve assembly; at least one temperature sensor to detect the temperature of the fluid or gas in the valve assembly; at least electrical power generator that generates electrical power from fluid flowing through the valve; at least one processor connected to each of the electromagnetic valve, the pressure sensor, the flow rate detector, the viscosity sensor and the temperature sensor, wherein the processor is capable of controlling the position of the valve based on the information obtained from the pressure sensor, the flow rate detector, the viscosity sensor and the temperature sensor; at least one communications module connected to the processor capable of transmitting to and receiving information from at least one of other valves in the valve network or a control unit; at least one security module mounted on the valve and connected to the communications module and the processor, wherein the security module is capable of sending information obtained from the valve assembly to the valve network of the status of the fluid or gas flowing through the valve assembly; and at least one power source that provides power to the valve assembly, processor and communication module, and the security module and is charged and/or recharged by the electrical power generator. In another aspect, the communication modules use at least one of GPRS, GSM, RF, WiFi, Ethernet, Zig Bee, or Bluetooth, to communicate within the valve network. In another aspect, the power source is selected from at least one of a battery, a fuel cell, a power generator, a solar panel, and an electrically connected line across the valve network. In another aspect, a secondary communication system is connected to the valve is selected from communication line, a fiber optic line, an Internet, a satellite, a telephone system, and an intranet. In another aspect, the at least one of the communications module of the valve network is capable of communication with a remote land-based location and an offshore surface location. In another aspect, the method further comprises a control unit that comprises a secure satellite communications module, a valve control processor, a processor with preconfigured parameters for operating the valve if communications are lost with the valve and one or more webservers that can control additional valves of the valve network. In another aspect, the valve is actuated magnetically, electromagnetically, mechanically, electrically, electromechanically, hydraulically, or pneumatically. In another aspect, the security modules comprises one or more cameras, motion sensors, or IR sensors that send information about the physical status of the valve to the valve network.

Yet another embodiment of the present invention includes a valve controller for a valve network comprising: one or more valve control processors that receives input from one or more valve sensors in a valve, wherein the processor comprises one or more preconfigured parameters and adaptive intelligence instructions for operating a valve if communications are lost between the valve and the operator that allows the controller and the valve to act independent of immediate, direct user input, one or more webservers that can control additional valves of the valve network; and one or more secure satellite communications modules under the control of the processor capable of communicating with the valves in the valve network and one or more user control centers; and one or more power sources that provides power to the processor, the webservers and the satellite communications module.

Yet another embodiment of the present invention includes a valve for connecting to a valve network comprising: at least one valve assembly, the valve assembly comprising: at least one valve to control a fluid or gas flow through an opening in the valve assembly; at least one pressure sensor to detect the pressure of the fluid or gas in the valve assembly; at least one viscosity sensor to detect the viscosity of the fluid or gas in the valve assembly; at least one flow rate detector to detect at least one of the flow or the volume of the fluid or gas flowing through the valve assembly; at least one temperature sensor to detect the temperature of the fluid or gas in the valve assembly; at least electrical power generator that generates electrical power from fluid flowing through the valve; at least one processor connected to each of the electromagnetic valve, the pressure sensor, the flow rate detector, the viscosity sensor and the temperature sensor, wherein the processor is capable of controlling the position of the valve based on the information obtained from the pressure sensor, the flow rate detector, the viscosity sensor and the temperature sensor; at least one communications module connected to the processor capable of transmitting to and receiving information from at least one of other valves in the valve network or a control unit, wherein the secure communications module is capable of sending information obtained from the valve assembly to the valve network about the status of the fluid flowing through the valve assembly; and at least electrical power generator driven by an impeller, propeller, screw-drive, paddle, or turbine positioned parallel to a fluid flow axis of the valve that provides power to the valve assembly, processor and communication module.

### BRIEF DESCRIPTION OF THE DRAWINGS

For a more complete understanding of the features and advantages of the present invention, reference is now made to the detailed description of the invention along with the accompanying figures and in which:

FIG. 1 shows a side and front view of the valve of the present invention.

FIG. 2 shows a top view and a side view of a valve of the present invention.

FIG. 3 is a flowchart that describes the operation of one type of valve of the present invention designated M2.

FIG. 4 shows a front view of a valve controller or robot, designated M1, for use in controlling, monitoring, updating, and/or communicating to and from the valves and valve network of the present invention.

FIGS. 5A and 5B show a flowchart that describes the operation, and the communications and feedback processes, of the M1 controller unit or robot with one or more valves of the valve network of the present invention.

FIG. 6 shows a data processing plan or flowchart for the intelligent data module designated M3 for use with the one or more valves of the valve network of the present invention.

FIG. 7 is a flowchart that describes the operation, and the communications and feedback processes, of the M3 unit with controller and the one or more valves of the valve network of the present invention.

FIG. 8 shows an internal view of the communications module or unit designated M4 of the present invention.

FIG. 9 is a flowchart that describes the operation of, and the communications and feedback processes of the M4 communications unit.

FIG. 10 shows a side view and a front view of a an MP unit of the present invention and the power unit designated MP.

FIG. 11 shows a top view and a second side view of a an MP unit of the present invention and the power unit designated MP.

FIG. 12 is a flowchart that describes the operation of, and the powerflow of the MP unit with the sensors and other units of the one or more valves of the valve network of the present invention.

FIGS. 13A and 13B show a flowchart that describes the operation of, and the powerflow of the MP valve unit, the M1 controller, the M2 valve, the M3 intelligent unit and the M4 communications unit of the valve network of the present invention.

FIG. 14 shows the overall topography of the valve network of the present invention that shows the interconnections between the individual valve units of the valve network, the M1 controller, the intelligent control unit M3, the communications unit M4 of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As used herein, the term “communications module” refers to a device for analog and/or digital transmission and/or reception of signals for communication purposes via electromagnetic radiation propagating, for example, through vacuum, air, or a generally non-conductive medium to or from another device. A wireless communications module may use signals formatted for communication with one or more wireless networks according to one or more of a number of communication systems including but are not limited to wireless networks such as cellular or satellite phone networks, 2G, 3G, 4G, GSM, CDMA, WCDMA networks, Municipal Wi-Fi, GPRS, iBurst, WiBro/WiMAX, UMTS-TDD, HSPA, EVDO, LTE, wireless local area networks, WiFi, WiMAX, personal area networks, Bluetooth, Wireless USB, ZigBee, Digital Enhanced Cordless Telecommunications (DECT) or other current or future wireless communication systems. A wireless terminal may be configured in one or more of various forms of handheld/mobile and/or stationary communication, control and/or computing devices as described with each of the various communications units of the present invention. The skilled artisan will recognize that the above abbreviations are standard in mobile telephony systems in a wide range of bands (e.g. 800, 900, 1800, 1900 MHZ, 2.4 GHz and 5.2 GHz ranges), e.g., Global System for Mobile communications (GSM), Advanced Mobile Phone System (AMPS), Digital-AMPS (D-AMPS), Code Division Multiple Access (CDMA), Wideband CDMA (WCDMA), Time Division Multiple Access (TDMA), Cellular Digital Packet Data (CDPD), Enhanced Data rates for GSM Evolution (EDGE), General Packet Radio Service (GPRS), Integrated Enhanced Data Network (iDEN), Orthogonal Frequency Division Multiplexing (OFDM), Orthogonal Frequency Division Multiple Access (OFDMA), Universal Mobile Telecommunication System (UMTS), 3rd Generation Partnership Project (3GPP), Wireless Fidelity (WiFi), Worldwide Interoperability for Microwave Access (WiMAX), RF Identification (RFID), Universal Mobile Telecommunications System (UMTS), UMTS Long Term Evolution (LTE) and Wideband CDMA (W-CDMA), as well as High-Speed Downlink Packet Access (HSDPA), High-Speed Uplink Packet Access (HSUPA), and Enhanced Data rates for GSM Evolution (EDGE) standards and other similar wireless (terrestrial or airborne) protocols.

The present invention includes: (1) a universal smart valve with actuator (hydraulic, electric, motor-electric, electromagnetic) called “Machh2” (M2 or M2 valve) with a main operation of magnetic type has two holes: one input (Gas, Petrol, Diesel, any other oil or other product in its liquid, semi-liquid, slurry, or gaseous) and one outlet. The valve has a horizontal axis that includes, e.g., a ring mechanism, which operate as electromagnetic actuators-powered operation. In one example, the system acts by turning the magnetic device in a circular loop in the clockwise direction to close, and opposite to open. The valve in its inner lining can have a volumetric sensor that determines the volume and speed of the product (in its liquid or gaseous), which pass through the M2 valve. The inside of the valve assembly also includes a viscosity sensor (e.g., when liquid products flowing through the valve), a pressure sensor for both liquid and gaseous products, and which is necessary to determine the level of internal pressure of the pipelines, temperature and the product (liquid or gas) that pass through the M2 unit may determine the degree of heat transported material. Similar to the other sensors, the temperature can be included not only in the valve but elsewhere through the entire pipeline, including other valves of the present invention. On the outside of the valve assembly includes one or more communication modules, which can transmit and receive signals in different forms, including, analog, pulse, digital, or any other advancement in wired or wireless communications, that controls and provides information about the valve assembly to the valve assembly network. The input/output signals are connected to a special unit called Machh Four (M4 communications unit), which has an intelligent module Radio frequency that can selected from various wavelengths, e.g., between 2.4 Ghz and 5.2 Ghz. The M4 unit delivers the information from the internal modules: Temperature, Volume, Velocity, Viscosity and intelligent pressure control unit M1. On the other hand, the communication module sends and receives instructions for closing and opening the flow of material in the unit M2.

It should be noted that the valve assembly may have additional auxiliary outputs like the M2 communication ports, allowing any team link controller (M1 or similar unit, satellite communication, GSM, GPRS, WiFi, Ethernet, etc.) to be operable individually. This auxiliary port will also serve to set the unit on the network “mesh” with a handheld unit that M2 is recognized by the M1 controller or robot, whose operation can control, on site or remotely, the overall system operations of the valve network, including each valve of the valve network or the entire network of intelligent valves. The M1 controller will generally include a control unit that includes a secure satellite communications module, a valve control processor that receives input from the valve sensors, a processor with preconfigured parameters and adaptive intelligent software for operating the valve if communications are lost between the valve and the operator that allows the controller and the valve to act independent of immediate, direct user input, and one or more webservers that can control additional valves of the valve network.

The following security protocols may be used with the present invention. The M2 valve can include smart sensors that detect movement or any kind of situation and will be connected externally via Radio (M4) with Machh1 controller or control unit (M1 controller) and the system Smart Cameras (ISC5). Additionally, the M1 controller can be positioned on the M2 valve directly, e.g., at the top and side (both sides) a closed system, of the M2 valve can also be operated manually. The intelligent M1 controller will have a built-in radio system on the inside, which will be compatible with the internal radios and operation within the M2 valve. The radio system into the Robot (M1), worked between 2.4 GHz and 5.2 GHz ranges. The M1 controller will also be equipped with communication protocols Zig Bee, WiFi, Ethernet, Modem, GPRS, Satellite and GPS position will emit constantly, like the position of all units ICS5 of M2, and in the field. The user can use the M1 controller to adjust any connection and communication system. The M1 controller can control up to 1064 M2 units, and can perform the following operations: receive all information from the Machh2 (M2), as also security system external cameras located along the pipelines. M1 controller can send all the packages of previously processed information to the control center via any media in the drive previously configured depending on the area where they are located valve assemblies of the present invention, the networked system, and other communication outlets in that area. The M1 controller can send packets to the central unit (M3) using the following protocols: Satellite, GPRS, Modem, Ethernet, WiFi, Zig Bee, Bluetooth, etc.). The M1 controller can also open and close the valve automatically, depending on pre-configured parameters and instructions from the control center Machh3 (M3).

Following the communication of the M1 controller with the valve M2, if for some reason the communications signal is lost (e.g., between the M1 and M3 by external situations (bad weather, storms, dropped signal, instruction request not processed by M3)), the M1 controller will have the responsibility of controlling security system of pipelines and Smart Cameras (ICS5) located strategically, taking control over images, problem determination, geospatial location of the unit and/or units M2 in trouble and run actions to resolve any issues that interrupt the normal operations of the complete system. All this is perform autonomously through its ability of artificial intelligence, and can even send reports via continuous and periodic emails and SMS to engineers and staff responsible for the pipeline.

On the other hand, the M1 controller can also have the ability to support up to 5 “webservers” internally, which means that M1 controller can also act as a server, i.e., independent of the visualization of the M1 valves in the field through the M3 unit (see below). The authorized personnel can access the M1 controller from a computer or mobile phone to access any field M1 controller directly, and send instructions to the M1 controller. The virtue of possessing one or more “webservers” internally, allows the M1 controller to divide each webserver on specific functions and can also be pre-configured, for example, for security webserver, webserver to control pipelines through M2 valves and M4 units (mesh system). The M1 controller is also able to supervise other units along a line, include the pumping station and control of the latter, if applicable. The M1 controller can also have the ability to store data of the complete system including security and smart cameras (ICS5). The package of photos and videos, may be viewed by accessing the valve unit (M1) remotely, which may also send such information in a transmission of compatible packages via satellite to the control center ICS5.

Software Platform and intelligent control Machh3 (M3). The M3 unit is an intelligent software platform equipped with artificial intelligence capable of controlling each of the valves in the valve network from a main office, or an unlimited number of M1 valves (or valve unit MP if the various modules are integrated the valve(s)). The M3 platform receives the information packets sent by the M1 (or MP) and once received performs three important tasks:

1. Make M1's log units (or MP) identifying runs, and identifies parameters that identifies current problems or issues in the network and predicts possible future problems according to the packet of information given by M1's units.

2. Make records M2 units (or MP) in field operation parameters identified in both M2 (or MP) and throughout the pipeline and like the previous feature, is able to identify actual problems in the whole line and possible future situations.

3. The M2 units have the responsibility and are capable of identifying abnormal situations throughout the pipeline through smart cameras located throughout the pipeline. This intelligent camera system known as ICS5, can deliver information to M1 (or MP) about abnormal situations and can also identify possible threats to security and stability of the product (in its gas and liquid) being transported through the pipeline. For examples, the valve unit can detect changes in the viscosity, flow rate, temperature and/or pressure to determine if water is being added to the pipeline, thus identifying the location between valves of theft. It can also detect rapid changes in pressure, temperature, and/or flow rate to identify the site of vandalism, problems with pipeline (blockages), explosions or other acute problems with the pipeline or continuous and slow blockages over time (chronic pipeline problems).

In either of the above cases, if there were to abnormal situation (a security problem or operation of any of the units in field-M1, M2, M4, or ICS5 MP) the system has the ability to locate and determine the problem with its respective image and geospatial position. In the first case, instructions to staff are requested from the control center, however, if the valve assembly or the M1 controller does not receive instructions in a timely manner, it can act in accordance to the given conditions and the situation after a pre-programmed time. That is, the system can independently take control with preconfigured reaction patterns programmed into the valve assemblies or via the robots. For example, in the M3 unit, the entire process can be loaded into a database, which can be fed continuously, and provides a basis for analysis of different mathematical models of network behavior. The units can also include advanced software that making decisions based on predetermined schemes and probability models rational expectations of future action.

The Machh 4 (M4 communications unit) is a smart radio device that is responsible for connecting the units M1, M2 (or in the case of the Machh MP unit for Machh Power unit, or MP unit) and Radio Frequency ICS5 (ICS5) by generating a strong and robust mesh (“Mesh”) of information where information flows from one valve unit to another, serving not only as a transmission channel for information, but also a powerful network security, ensuring the efficient operation of equipment operating in the field. The M4 Unit includes batteries with a 10-year life and system “backup” power to save the encrypted data up to 5 years of suspended operation. The M4 is an important role in establishing a robust and redundant conduit for information with regard to what is happening throughout the pipeline through the precise values of the different internal sensors to unit M2 (or MP) as also of all that may occur in the area where the pipeline is located, which is work done by the ICS5.

ICS5. Intelligent System security cameras with image sensors, able to take a view of up to 3 miles with full clarity of detail, able to detect a security risk and immediately alert the control center through its immediate field coordinator: M1 (or the MP unit). These smart camera units (ICS5), will have its own redundant power supply, making it less vulnerable with the purpose of staying in operation even if other parts of the valve M1 fail or run out of power. This camera system can use any of the current cameras that meet these design criteria.

Machh Power (MP). Machh Intelligent Power System, is an integration of units: M1, M2 and M4 and/or M1 and M3. This system is designed for particular situations where more compact units require heavy duty and more control. It is ideal for structures such as gas pumping substations and control units, including, e.g., those in very remote locations or locations that are difficult to access, e.g., underwater or in difficult terrain. The operation process Machh Power is determined exactly as the previous units, but in this last case, will be integrated into one body. The power generation from within the valve will be selected to be heavy duty, which will often be necessary for very large valves.

The comprehensive security and intelligent system thus includes a valve (M2) that can be used with liquid and gaseous products, a unit with artificial intelligence (M1) which take delivery of radio signals from other valves (M2) through the intelligent module (M4) and an intelligent system of cameras installed along the pipelines called ICS5. The M1 Unit can execute actions under certain parameters as indicators of behavior in pipelines, indicators that can be provided in real time and continuously for M4 units, which will be inside the unit M2. This M4 unit will allow transmission of radio signals that includes all the parameters of what is happening both inside and outside of the M2 valve unit, and also everything that happens in the intelligent system and security cameras ICS5. The system will be equipped with a control unit (M3 unit), which interact constantly and continuously with the M1 controller, the M2 valve unit and the ICS5 camera through intelligent radio unit M4 or M4 communications unit.

The system in its entirety will be communicated between the M1, M2 and ICS5 via radio M4, and between the M1 unit and M3 unit, preferably via satellite, however, you can use any of the following means of communication: GPRS, GSM, RF, WiFi, Ethernet, Zig Bee or any other advanced communications protocol, which may be a primary or backup method of communicating. It should be noted that the whole system will often be “wireless”, but can also include wired communications, if applicable, to or between one or more valves of the valve network.

Thus, the present invention is an intelligent integrated system safety valve consists of a special (Machh2) whose use is applicable to liquid and gaseous products, a unit with artificial intelligence (Machh1) which sends and receives signals via radio waves (Machh2—M2) by a module called Smart Machh4 (M4) and an intelligent system of cameras installed along the pipelines called ICS5. The M1 Unit executes actions under certain parameters as indicators of behavior in pipelines, indicators that will be provided in real time and continuously for M4 units, which will be inside the unit M2. The M2 unit will allow transmissions via radio M4, including data about events that happen on the inside and outside of the unit M2, and also everything that happens in the intelligent system and security cameras ICS5. The system will be equipped with a control (Machh3 (M3)), which interact constantly and continuously with Machh1 (M1), the Machh2 (M2), and ICS5 through intelligent radio unit Machh4 (M4).

Generally, the M4 unit will be inside of or adjacent to the M2 unit or the MP unit, collecting data from all sensors: Pressure, Volume, Flow Rate, Viscosity, Temperature, Motion Sensors, and Security External Sensors. The M4 unit will receive and send information about operations and instructions in M2 unit (or MP unit). The M4 unit will be on line with all the M2 units (or MP unit) and M1 unit nearest through an intelligence RF signal, which will be able for to build a strong mesh between (all MP units for the integral case) M2 and M1 units in field.

With regard to the intelligent RF transmission module, it will generally be able to do one or more of the following: interfaces into most devices or sensors; collects data from devices with analog, MBUS, BACnet, digital voltage or pulse generated by sensors or devices; transmits data to devices for control or change of state; stores data locally; transmits to any node in its mesh system; operates on 2.4 GHz or 902-928 MHz; can be a repeater for other radios in its mesh system; and can have a 10 year battery life.

As such, the Machh system (M1 unit, M2 unit, M3 unit, M4 unit, MP unit and ICS5 unit) provides a complete alternative to alternative security systems that often places personnel is dangerous situations. The Machh system provides continuous monitoring of production and distribution of liquid, mixed liquid and gas, gas, and liquid with solids (e.g., petroleum products, such as natural gas or liquid (oil, diesel or petrol)), by determining on site, using a single adaptable valve unit M2 that monitors variables such as temperature, Viscosity, Volume, pressure and flow. Safety on the outside to the provided by the ICS5 system. The aforementioned variables, laboratories and processes currently needed in the field, using highly skilled workforce, which would no longer be necessary to send people to the ground, since the system would be self-sufficient to operate all pipeline networks. The M2 intelligent valve determines the behavior of each of these variables in a stable and continuous, as long as the product is through each valve M2 across a pipeline.

The intelligent Machh system, may identify through rigorous mathematical processes of value change target variables (temperature, viscosity, volume, pressure and velocity) of valve to valve throughout the pipeline, thus giving exact values for the flow rate, temperature, pressure, viscosity, etc., which are analyzed through an algorithmic processes based on artificial intelligence with clear instructions to alert the control center what is happening (also via emails and text messages to preconfigured cell) and even close immediately and automatically over product (oil, Petrol or Gas) but also Geospatial information about where a particular event is occurring and record images and video with the situation, doing all this in real time, which can them be transmitted and reported in seconds, and can also act without human intervention based on pre-programmed routines or adaptable routines. The above process will be done by the team “Robot” M1, which, will have processors and advanced software, running mathematical control software based on artificial intelligence.

The present invention can also operate in bad weather, storms, rain or any other incident of that nature that may cause a loss of communication with the M3 system, because while communication is restored, all M1 controller units in the field, are able to control and manage any type of incident, including closing the flow of material through the pipeline, if necessary. The M1 controller unit can easily convey everything that is happening to the central control location through various forms of communication: Satellite, WiFi, Ethernet, Zig Bee, RF or any other existing or developed in the immediate future. This is possible because the M1 controller unit can become its own “webserver”, which offers the possibility that it can directly interact with, via internet due to its quality of possessing up to 5 “webservers” internally, and the ability to control hundreds or thousands of M2 valves or devices on or about the pipeline. Each and every one of the valve units M2 and the M1 controller are “talking” and “communicating” continuously throughout the pipeline (water, oil, gasoline or natural gas). The system is made redundant with the M4 intelligent communications unit, which plays an important role in establishing a robust mesh intelligent, linked communication unit, that can also calculate mathematical patterns, which are the result of simultaneous differential equations designed to predict future events, which could destabilize the pipeline system as well as the system security. Once the complex mathematical model determines those values based on information taken from the internal sensors of the valve unit M2 and/or the external security system ICS5, the M1 or M3 units may decide to set function parameters in the system or if appropriate close material flow, thus avoiding catastrophes.

By calculating simultaneous and redundant mathematical models, the M1 and M3 units are equipped with the capability to control the valve units M2 though entirely logical routines, guided by intelligent platforms, which make unique and special compatibility with previously installed systems. Generally, the mesh network will be equipped with encrypted communication protocols with 128-bit high-level encryption (or higher), which not only makes the system robust, but also invulnerable and impenetrable to hackers. The system will have the ability to work under CRC mode (Error Checking expected), which will allow the system to heal itself, that is, to automatically address problems in the pipeline by virtue of artificial intelligence in its platform. This will be achieved considering a process of inhomogeneous differential equations of higher order, linked to dynamic models of probability, which gives the user the capacity to communicated via M1 and M3 and to predict what might happen under certain conditions with the values M1 based on multiple variables, objectives and environmental conditions in the system, which include data from the advanced security scheme (ICS5).

The intelligent system Machh, was designed to help improve operations in the field of oil and any other market that was necessary and useful application. It will help to ensure the safety of the team of engineers in an explosion or spill, who have to manually close the flow lines and exposed to high temperatures of combustion when the product is pouring or burning. The intelligent system can close automatically Machh all lines and control the flow at the central station, long before any disaster, ensuring complete safety and environmental field especially saving a lot of money to companies. This system is particularly against terrorist attacks, theft of product, control and monitoring of product pipelines, maintenance processes, data management, among others.

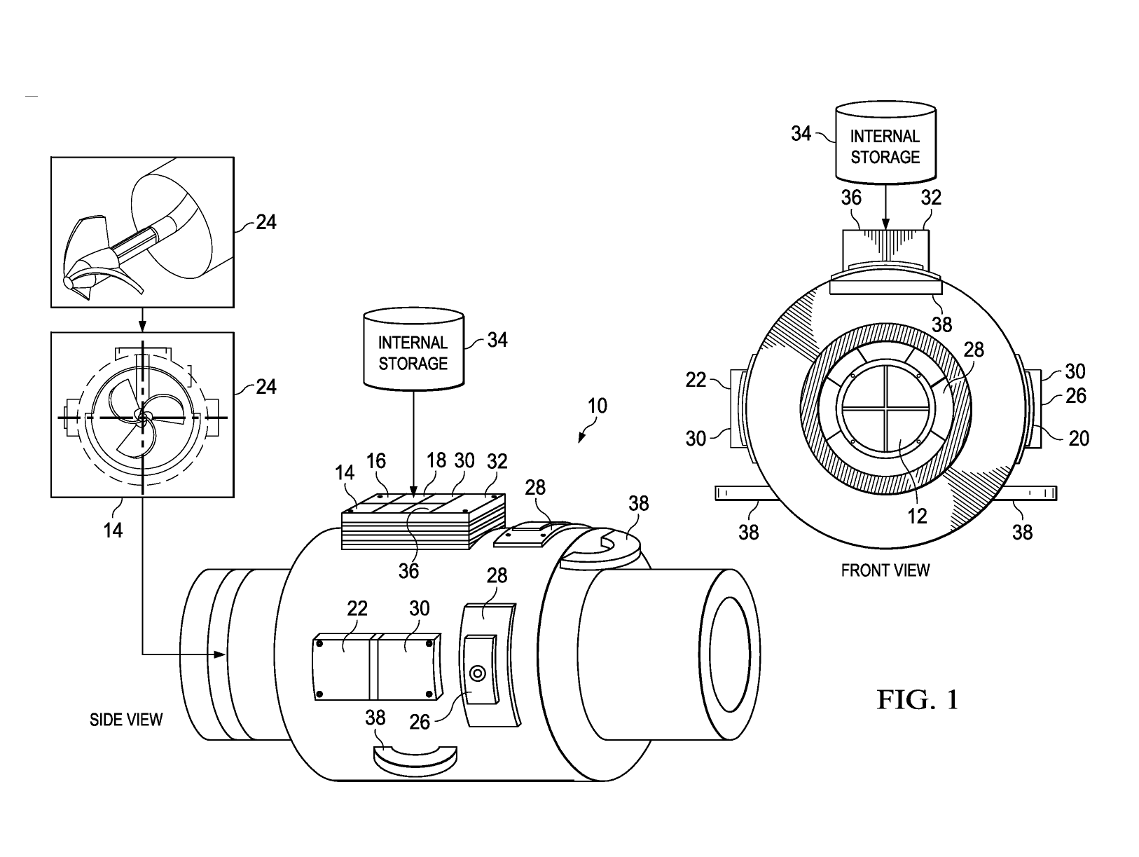

FIG. 1 shows a side and front view of a valve 10 of the present invention, which includes the main valve 12, the flow rate sensor(s) 14, the volume sensor(s) 16 (the flow rate and volume sensors may be combined or separate), the temperature sensor(s) 18, viscosity sensor(s) 20, pressure sensor(s) 22, an insert that shows the in-line power source 24 (depicted in this figure in the form of a propeller in exploded views) that is connected to a generator (not shown) that provides electrical power to the valve and the electronic components shown as the systems (manual and mechanical valve control 26, electromechanical or magnetic valve control 28, etc.), the external security system 30, the communications and data management unit 32, internal storage 34, an energy system 36, for the operation of the valve 12 and control of the sensor(s) 14, 16, 18, 20, 22. Also depicted are lugs 38.

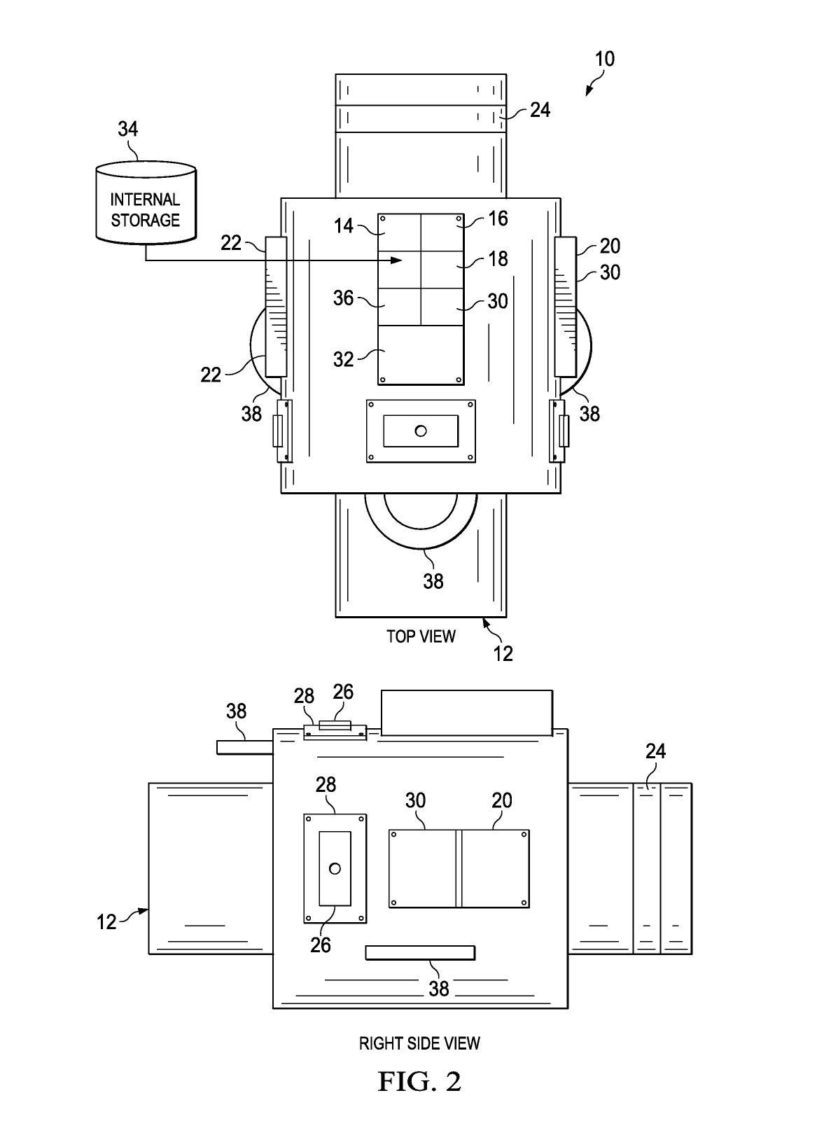

FIG. 2 shows a top view and another side view of a valve of the present invention with the like components as outlined hereinabove. The valve 10 of the present invention, which includes the main valve 12, the flow rate sensor(s) 14, the volume sensor(s) 16 (the flow rate and volume sensors may be combined or separate), the temperature sensor(s) 18, viscosity sensor(s) 20, pressure sensor(s) 22, an insert that shows the in-line power source 24 (depicted in FIG. 1 in the form of a propeller) that is connected to a generator (not shown) that provides electrical power to the valve, and the electronic components shown as the systems (manual and mechanical valve control 26, electromechanical or magnetic valve control 28, etc.), the external security system 30, the communications and data management unit 32, internal storage 34, an energy system 36, for the operation of the valve 12 and control of the sensor(s) 14, 16, 18, 20, 22. Also depicted are lugs 38.

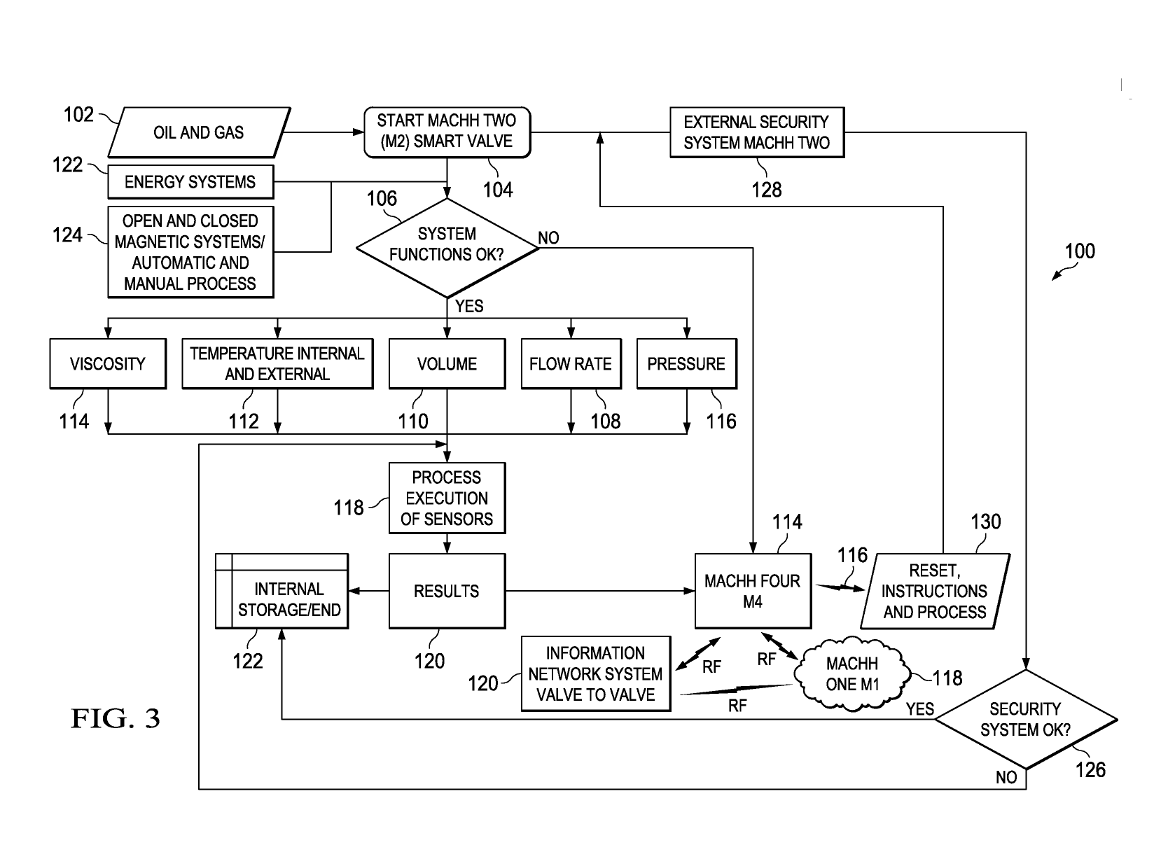

FIG. 3 is a flowchart 100 that describes the operation of one type of valve of the present invention in which oil and/or gas 102 enters the valve designated M2 104 in which the system begins by testing if the valve and its systems are operating properly 106, these then connect to the various sensors (flow rate sensor(s) 108, the volume sensor(s) 110, the temperature sensor(s) 112, viscosity sensor(s) 114, pressure sensor(s) 116, etc.), the data from the sensors 118 and the results 120 of which are stored 122 and/or transmitted 114 via a local wireless 116 or satellite network 118 to any between the valves 120 in the network. The flowchart also shows the energy system 122 and the valve opening system 124, as well as communication with the security system 126, which can control the operation of the valve at 128, including a reset process 130.

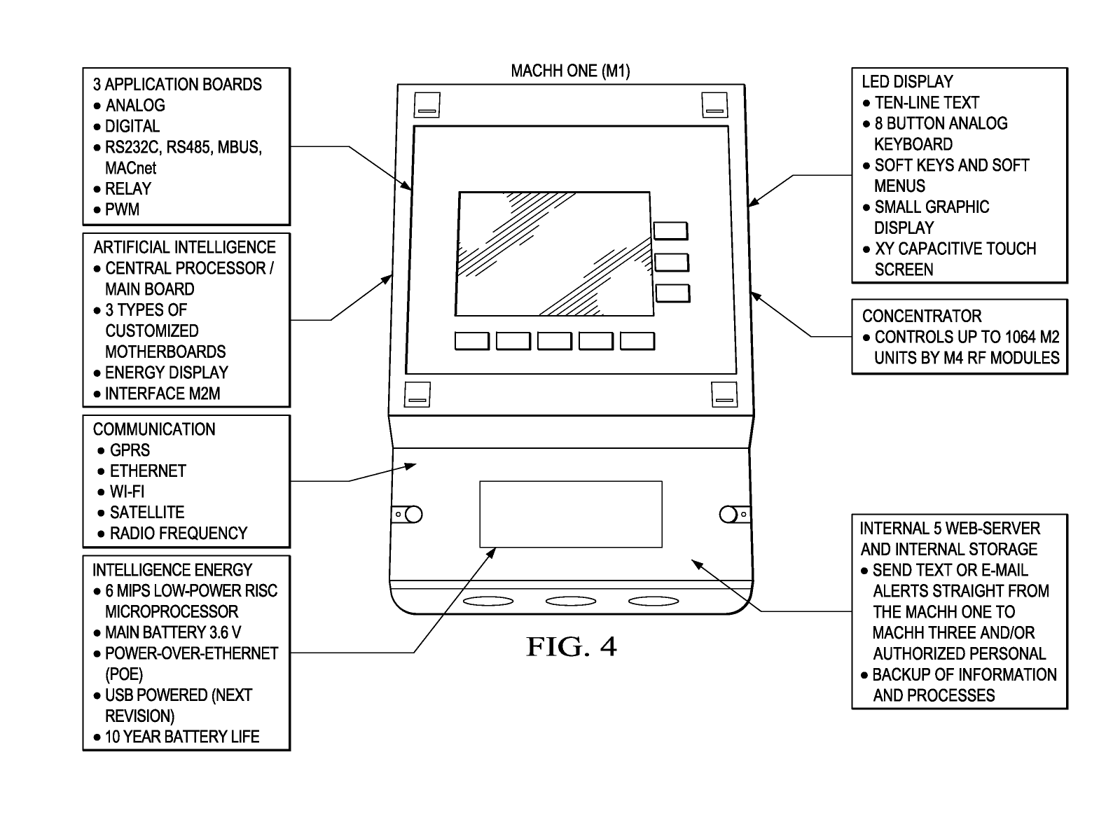

FIG. 4 shows a front view of a valve controller or robot, designated M1, for use in controlling, monitoring, updating, and/or communicating to and from the valves and valve network of the present invention. In one aspect, the M1 unit may have a 5 to 10-year, redundant battery supply that is able to fall asleep and be reactivated when needed by the M4 communications unit. The M1 unit can also include artificial intelligence software that can control any valve in a valve network, can include one or more webservers that can process information to and from any valve in the valve network, can process information for or from any of the valve units independent from the local valve processor. In certain embodiments, the M1 controller can be used to replace the processor on or about the valve and can be substituted or take over if the processor on the valve fails or if the valve does not have a processor and relies on the M1 unit for its data processing, e.g., data from the internal valve sensors, the communications network, the security cameras or redundant communications systems on or about the valve.

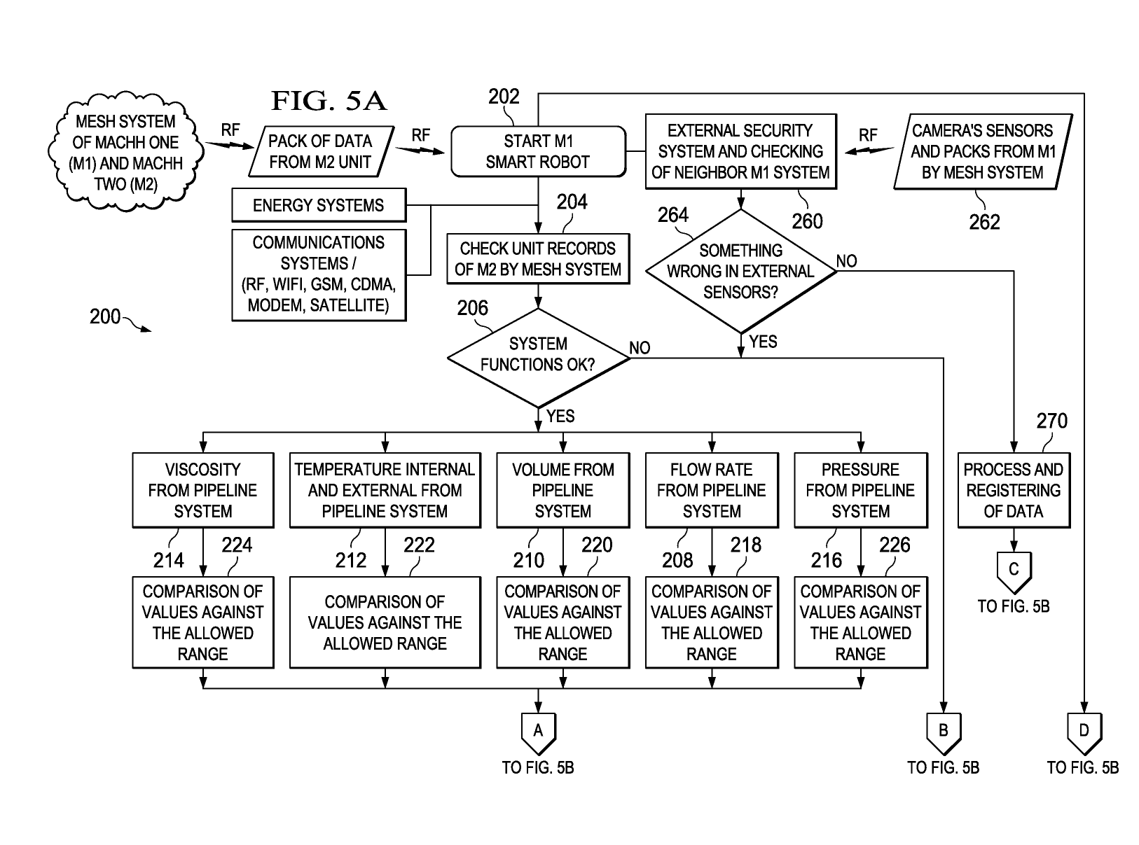

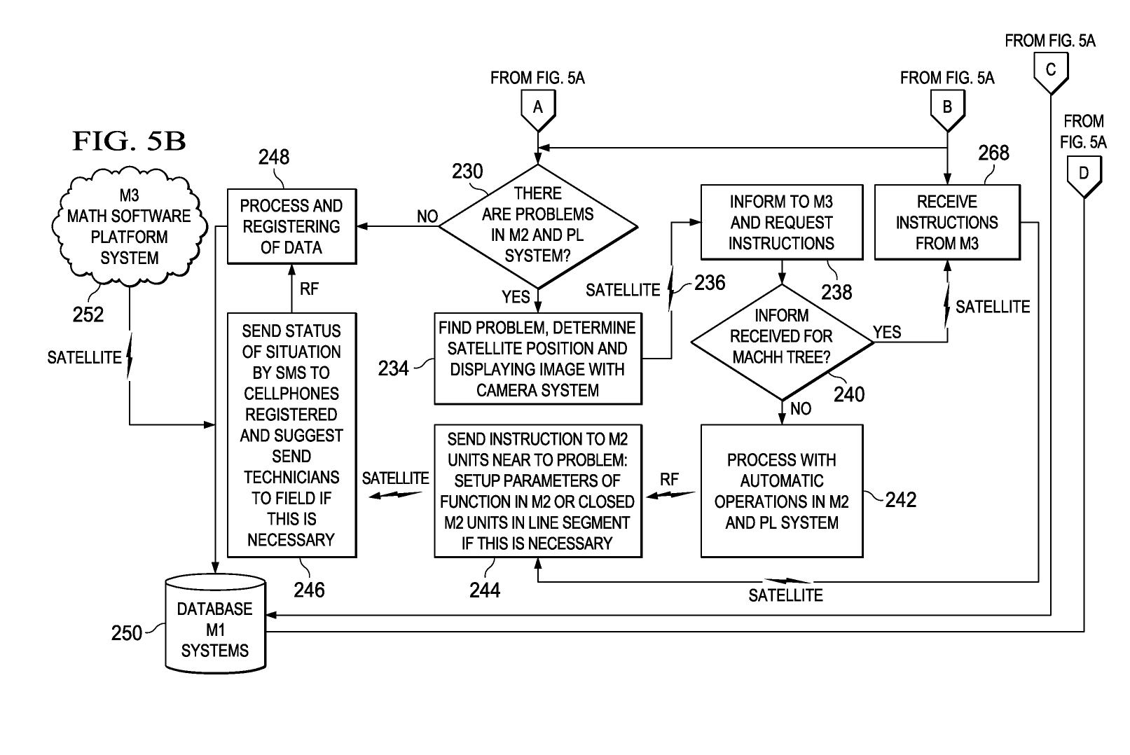

FIGS. 5A and 5B show a flowchart 200 that describes the operation of, and the communications and feedback processes of the M1 unit or robot 202 with one or more valves of the valve network of the present invention. The system begins by testing 204 if the valve and its systems are operating properly 206, these then connect to the various sensors (flow rate sensor(s) 208, the volume sensor(s) 210, the temperature sensor(s) 212, viscosity sensor(s) 214, pressure sensor(s) 216, etc.), the results of which are tested for compliance with values within the operating range 218, 220, 222, 224, and 226, respectively, and the data stored and/or transmitted via a local wireless or satellite network to any between the valves in the network. The M1 unit also tests the entire system and compares and determines whether the valve and its sensors are operating within the allowable range (218, 220, 222, 224, and 226). If problems are detected 230 then the unit determines the position of the valve in the network 234 and relays that information via wireless and/or satellite 236 to the other valves and/or the operator 238, including a decision tree 240, that follow an automatic process 242, sends instruction 244, and alerts a technician if necessary 246. Data is stored and/or registered 248, and sent to a database 250, which can communicate with the math processing platform 252. The system also obtains information from the security systems 260, which detects if anything is wrong 264, including information obtained from the security sensors and/or cameras 262 and relays that information to the user and controls the robot or valve 202. If necessary it accesses the redundant communications system in the M3 unit 268. The data is stored 250 and transmitted and/or stored or registered 270 for later transmission once communications are reestablished.

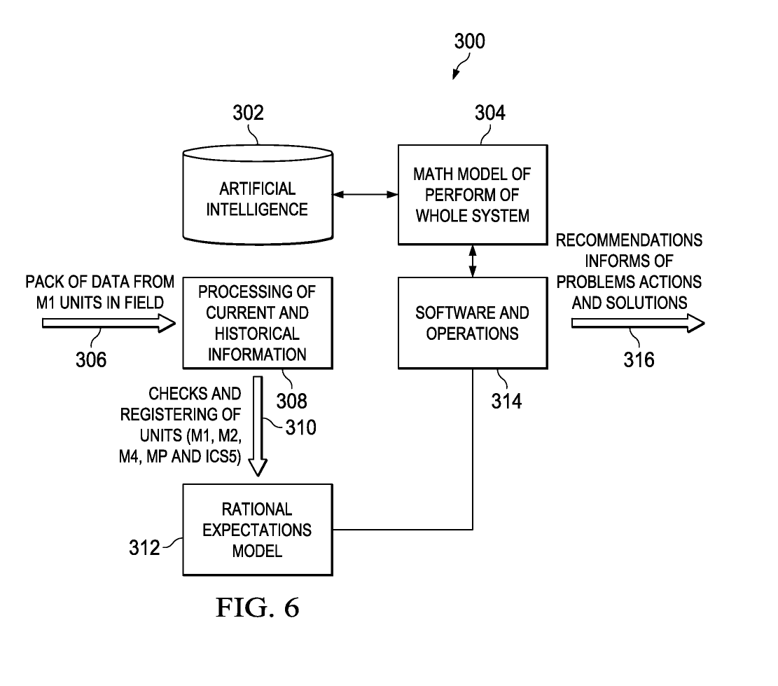

FIG. 6 shows a data processing plan or flowchart 300 for the intelligent data module designated M3 for use with the one or more valves of the valve network of the present invention in which the architecture of the artificial intelligence 302 of the system is shown to connect to a math model 304 for the operation of the pipeline and the positioning of the valves, which obtains packets of data from the field unit 306 (e.g., its sensors and its operating position, open, closed or in between) it is, which operation can also be compared to the changing data obtained from the sensors and the historical operations data 308, followed by checks from all the units 310. These data are compared to rational expectation model(s) 312 and parameters for the expected operation of the valve and the data from the sensors and this communicates via software and user input 314 to operate one or more valves of the valve network. All of these data are then used to provide recommendations for solutions to the operation of the valve network 316.

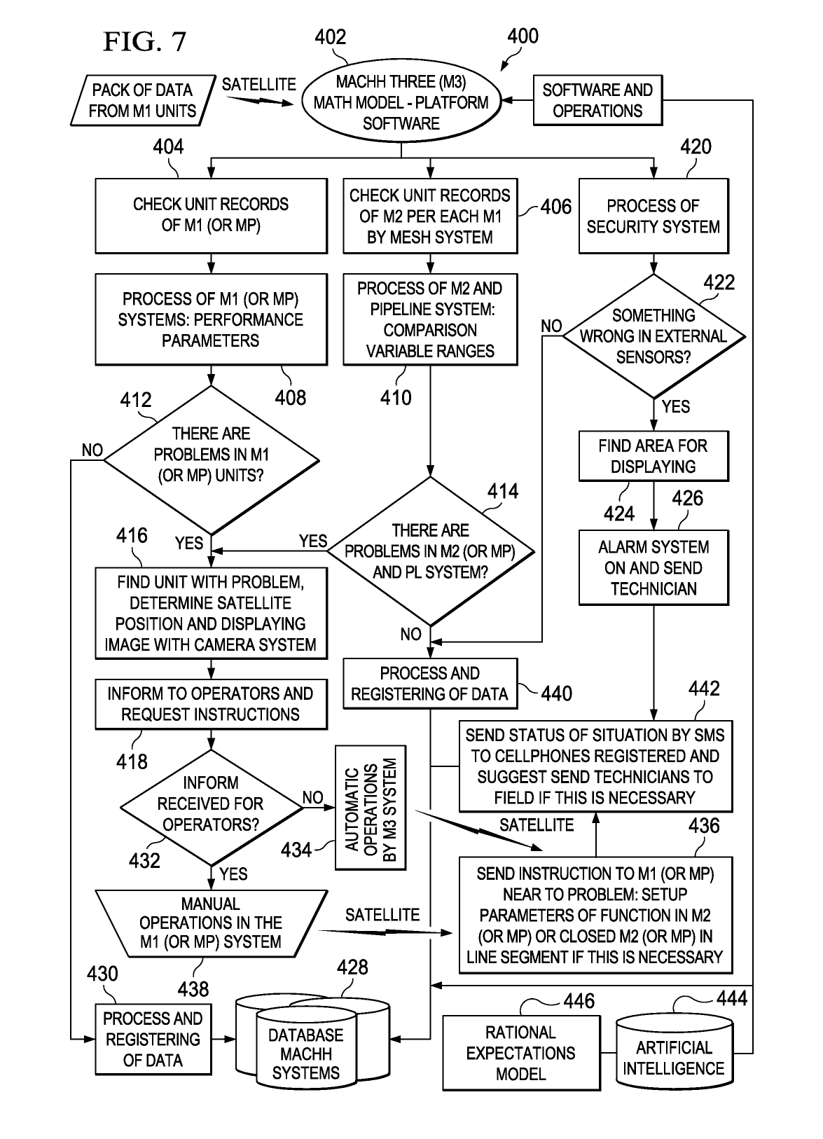

FIG. 7 is a flowchart 400 that describes the operation of, and the communications and feedback processes of the M3 unit with controller 402 and the one or more valves of the valve network of the present invention. The system begins by testing the operation of all the components of the valve network 404, 406, the results of which are stored and/or transmitted via a local wireless or satellite network to any between the valves in the network and performance parameters are evaluated 408, 410. The M1 unit also tests the entire system and compares and determines whether the valve and its sensors are operating within the allowable range. If problems are detected 412, 414, then the M3 unit determines the position of the valve in the network 416 and relays that information via wireless and/or satellite to the other valves and/or the operator 418, it informs the necessary operators 432 or processes and registers the data 430, can trigger the automatic operation of the M3 unit, which them communicates via satellite link the send instructions to valves in the network to perform corrective actions 436, and/or, permits manual operation of the units 438. The system can also obtain information from the security system 420, including security sensors and/or cameras, makes a decision 422, and relays that information to the user and/or process of register data 440, it also sends a status of the situation by SMS or cellphone to technicians in the field 424, 426. The M3 unit is also used to store registration information 428 and communicates with the M1 controller unit. Operator input is also obtained and stored for current status and future reference and can also send information via SMS or cellphones 442. If necessary it accesses the redundant communications system in the M3 unit. The data is stored and transmitted and/or stored for later transmission once communications are reestablished. The unit also communicates with the artificial intelligence module 444, that checks with the rational expectations module 446, which communicates with the database 428.

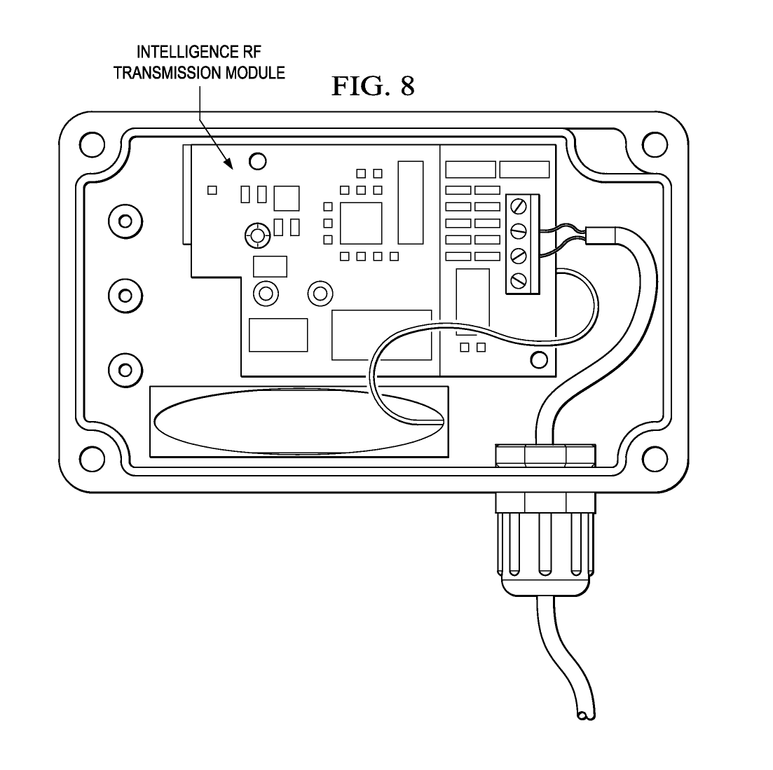

FIG. 8 shows an internal view of the communications module or unit designated M4 of the present invention. The M4 communications unit will generally have its own redundant power source (Battery back-up), but may also be connected to the main power source of the valve. The M4 communications unit module will check functions from the valve body in addition that it will send and receive information.

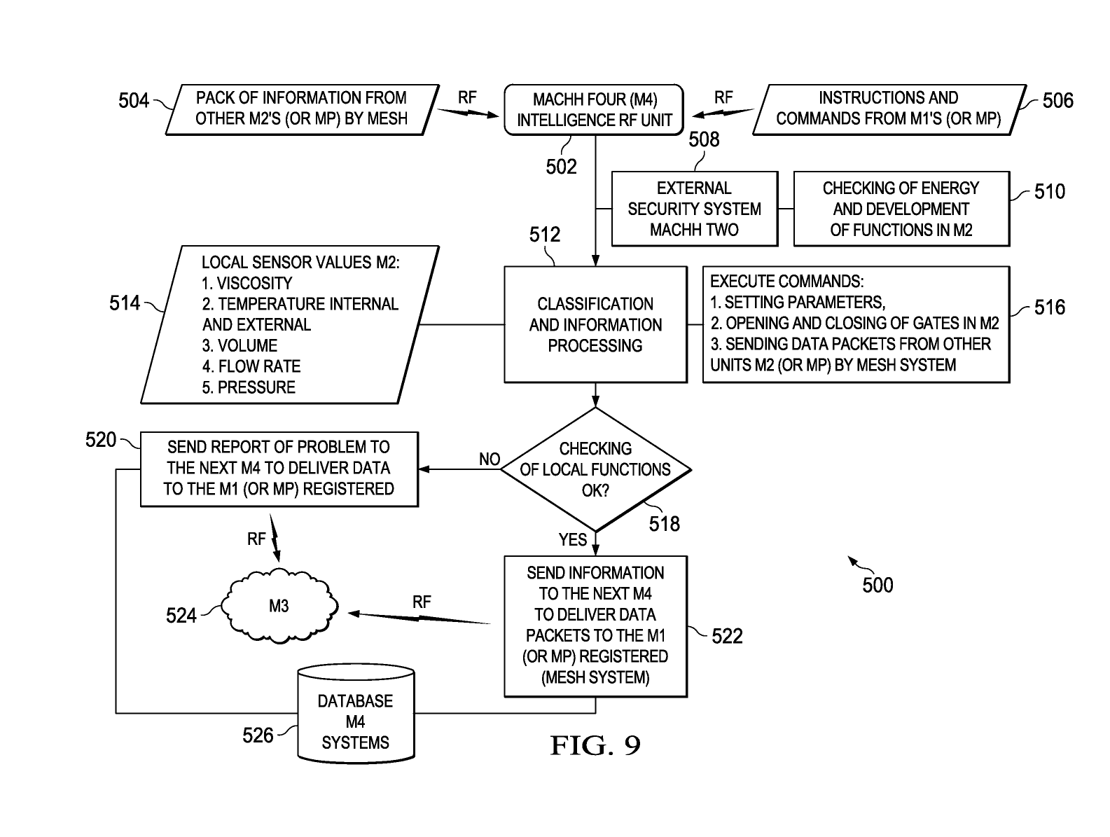

FIG. 9 is a flowchart 500 that describes the operation of, and the communications and feedback processes of the M4 communications unit 502 with controller and the one or more valves of the valve network of the present invention. The M4 unit has the responsibility of sending all the process and activities that are happening in the M2 504 to M1 506. The M4 receives the instruction from M1 506 about resent, close or open of valve, setup of parameters of sensors and the Security Systems 508 and to check the energy levels of the system 510. The M4 unit acts as an interface and make a strong “Mesh” of valve to valve communication which is able of build a network of valves. The system is able to classify and process information 512, communicate data regarding the operating position of the valve(s) and if its/their systems are operating properly, these then connect to the various sensors (flow rate sensor(s), the volume sensor(s), the temperature sensor(s), viscosity sensor(s), pressure sensor(s), etc.) 514, execute commands such as setting parameters, opening and closing valves, and send data packets 516. The results can also be stored 526 and/or transmitted via a local wireless or satellite network to any between the valves in the network or to a M3 unit 524. The M4 unit also tests the entire system and compares and determines whether the valve and its sensors are operating within the allowable range. If problems are detected 518 then the unit determines the position of the valve in the network and relays that information via wireless and/or satellite to the other valves and/or the operator, it obtains information from the security sensors and/or cameras and relays that information to the user 520, 522. If necessary it accesses the redundant communications system in the M3 unit 524. The data is stored and transmitted and/or stored for later transmission once communications are reestablished 526.

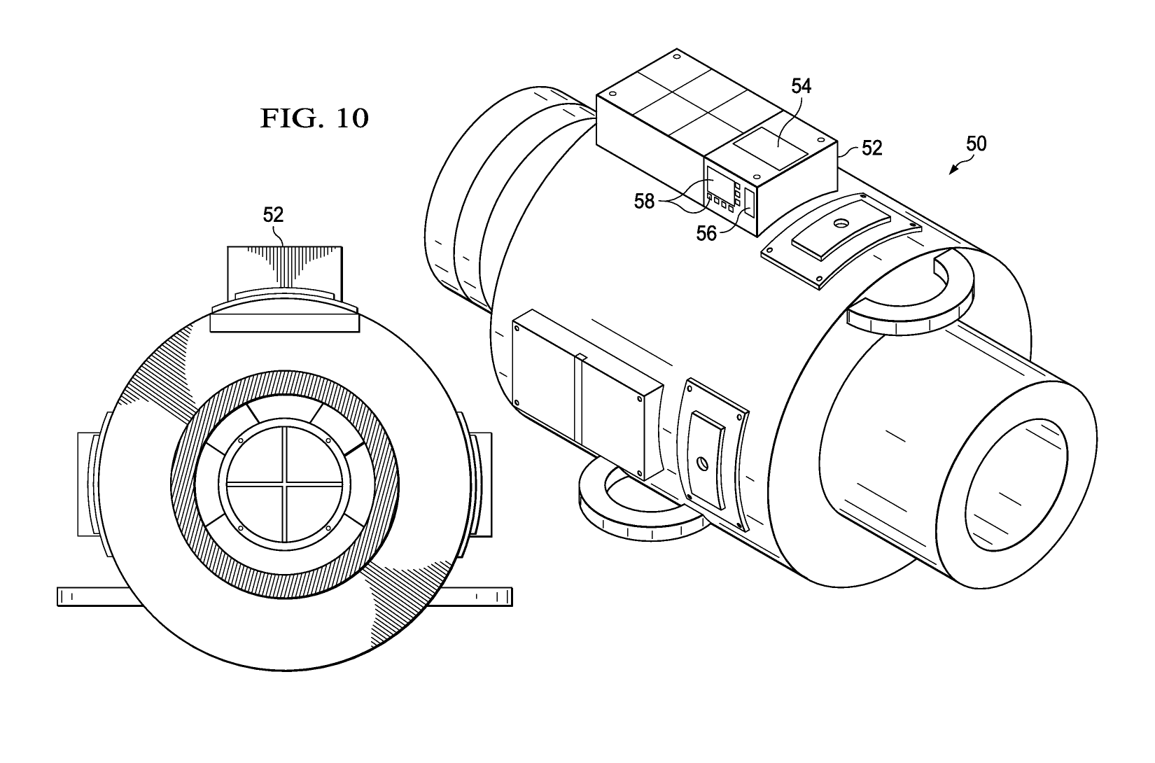

FIG. 10 shows a side view and a front view of a valve MP 50 of the present invention, which includes the M1 52, M2 54 and M4 56 units and a display unit 58.

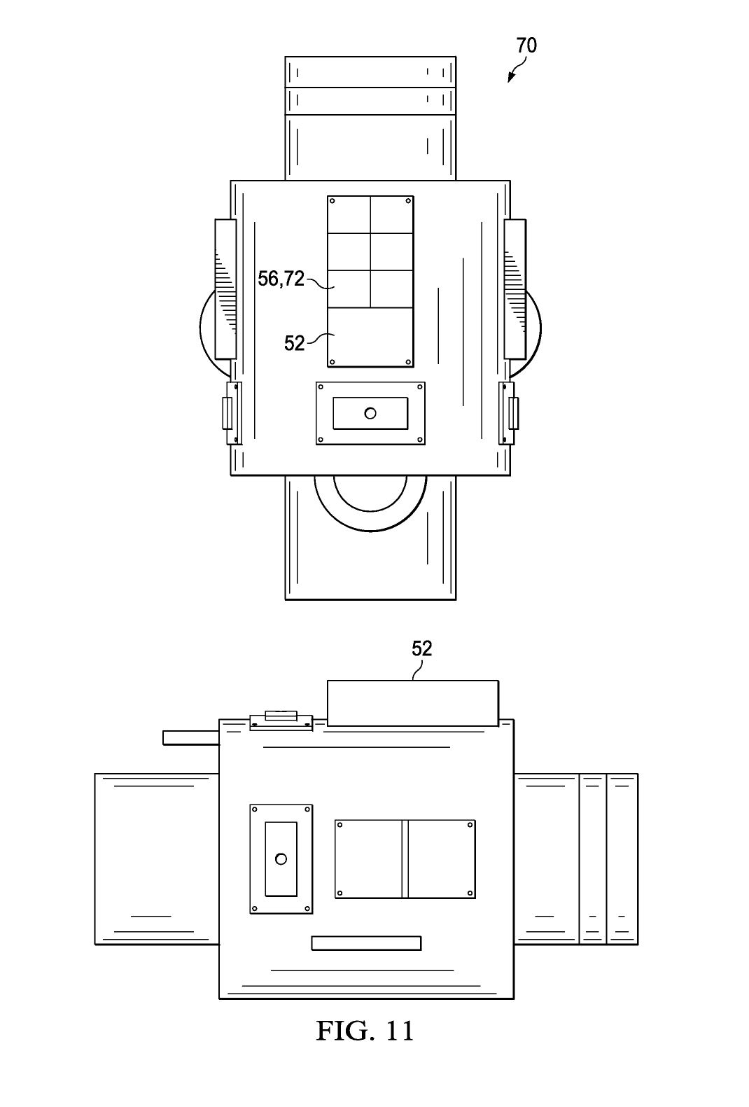

FIG. 11 shows a top view and a second side view of a valve M5 70 of the present invention, which includes the M1 52, M3 72 and M4 56 units.

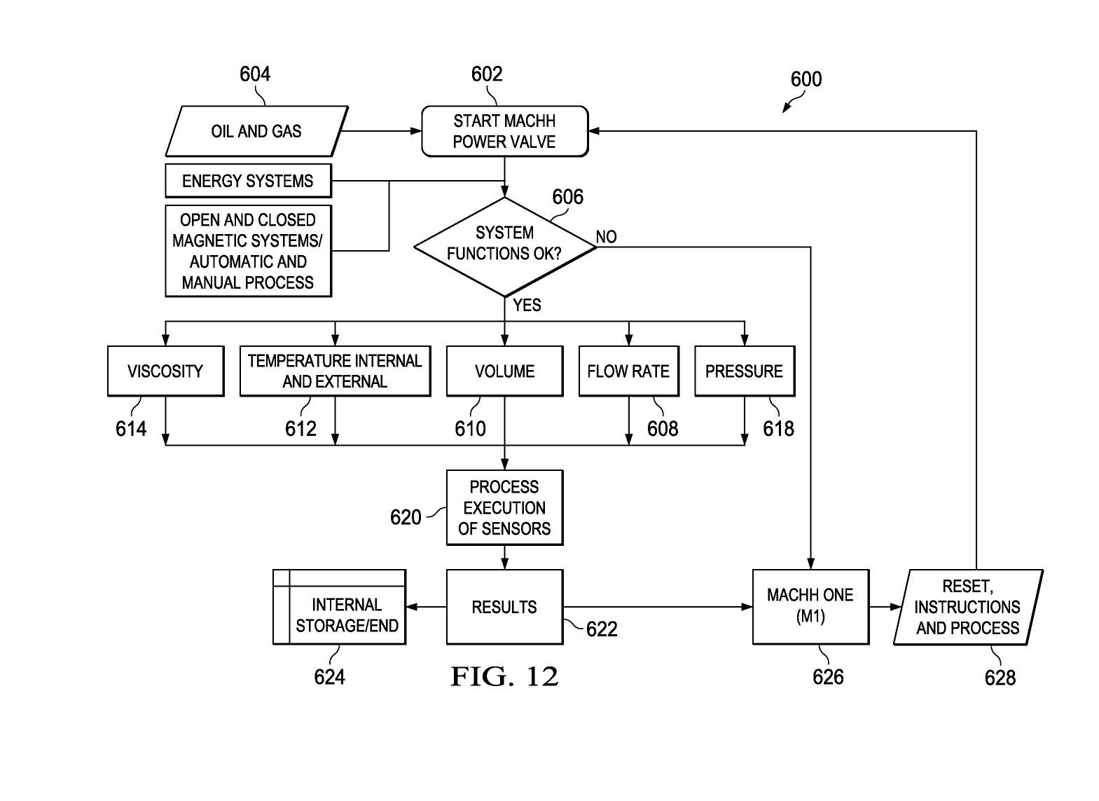

FIG. 12 is a flowchart 600 that describes the operation of the MP valve 602 for operations of, e.g., oil and/or gas 604, and the powerflow of the unit MP with the sensors and other units of the one or more valves of the valve network of the present invention. The system begins by testing if the valve and its systems are operating properly 606, these then connect to the various sensors (flow rate sensor(s) 608, the volume sensor(s) 610, the temperature sensor(s) 612, viscosity sensor(s) 614, pressure sensor(s) 618, etc.), the data is processed 620, and the results 622 of which are stored and/or transmitted 624 via a local wireless or satellite network to any between the valves in the network. If there is problem with the system, it communicates with the M1 unit 626. The M1 unit 626 can also test the entire system, and compares and determines whether the valve and its sensors are operating within the allowable range or the system is reset 628. If problems are detected then the unit determines the position of the valve in the network and relays that information via wireless and/or satellite to the other valves and/or the operator, it obtains information from the security sensors and/or cameras and relays that information to the user. If necessary it accesses the redundant communications system in the M3 unit (not shown). The data is stored and transmitted and/or stored for later transmission once communications are reestablished.

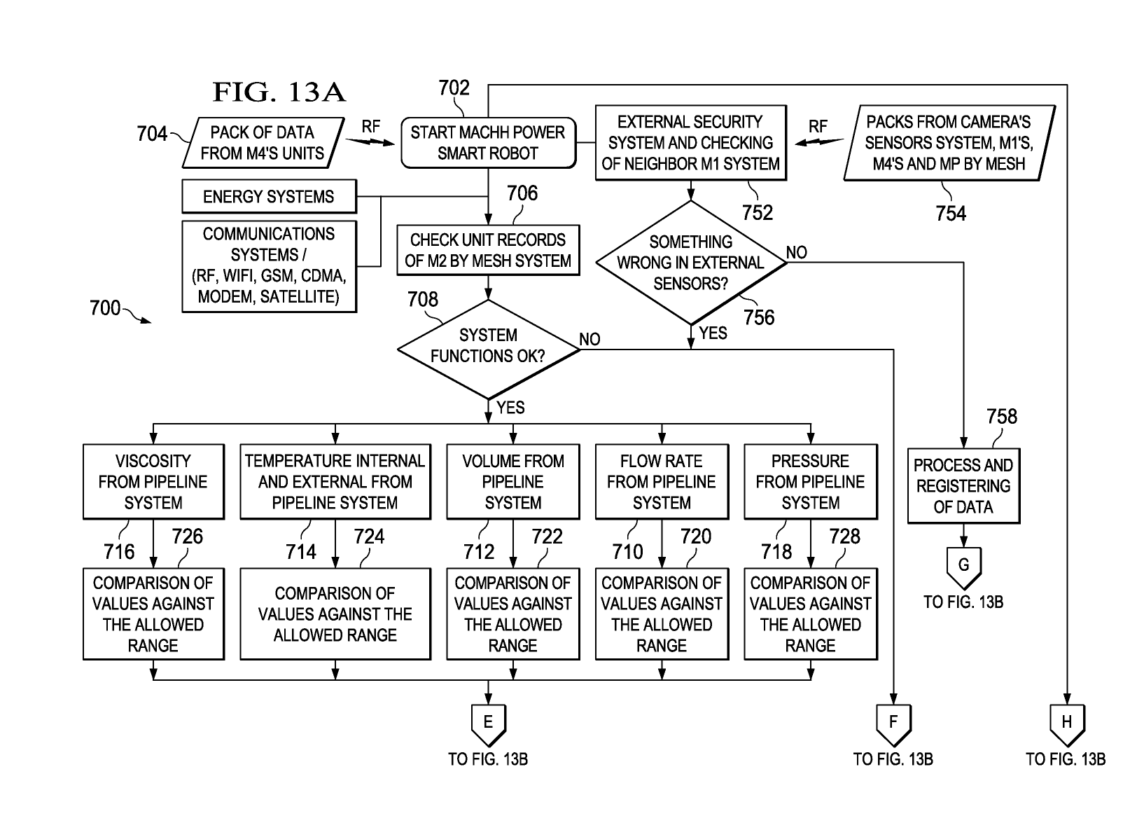

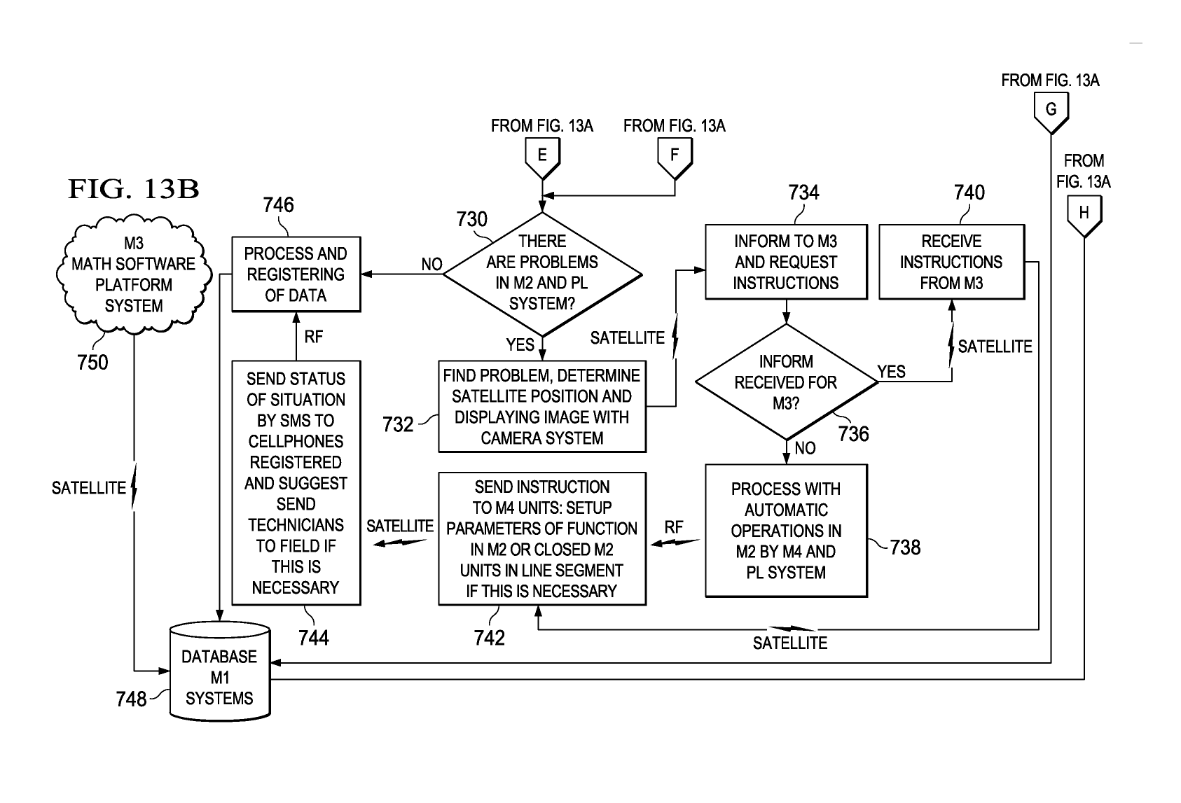

FIGS. 13A and 13B show a flowchart 700 that describes the operation of, and the powerflow of the unit MP, the M1 robot, the M2 valve, the M3 intelligent unit and the M4 communications unit of the valve network of the present invention. The system begins by starting the smart robot 702, which can receive data packets from M4 units 704, check the records of the M2 units 706 or communicate with the external security system of other M1 units 752. After the systems check 706, the system performs a self-test 708, to test if the valve and its systems are operating properly, these then connect to the various sensors (flow rate sensor(s) 710, the volume sensor(s) 712, the temperature sensor(s) 714, viscosity sensor(s) 716, pressure sensor(s) 718, etc.), the results of which are stored and/or transmitted via a local wireless or satellite network to any between the valves in the network. The M1 unit also tests the entire system and compares and determines whether the valve and its sensors are operating within the allowable range 720, 722, 724, 726, and 728, respectively. If problems are detected then the unit 730 determines the position of the valve 732 in the network and relays that information via wireless and/or satellite to the other valves and/or the operator via an M3 unit 734, which then decides 736, whether to process automatic operations using M2 and/or M4 units 738, or receive instructions from an M3 unit 740. In either event, the instructions are sent to other M4 units 742, which can also be sent via SMS or cell communications after satellite download or communications and technicians sent if necessary at 744. The data are processed and registered 746, and data is stored or communicated to a database 748. The database 748 can also be in satellite communications with an M3 software platform unit 750, e.g., in a data cloud. The system can also get data from a security unit 752, which can also obtain information from the security sensors and/or cameras 754 and relays that information to the user after determining if anything is wrong 756, and the data is registered and processed 758. If necessary it accesses the redundant communications system in the M3 unit 750. The data is stored and transmitted and/or stored for later transmission once communications are reestablished.

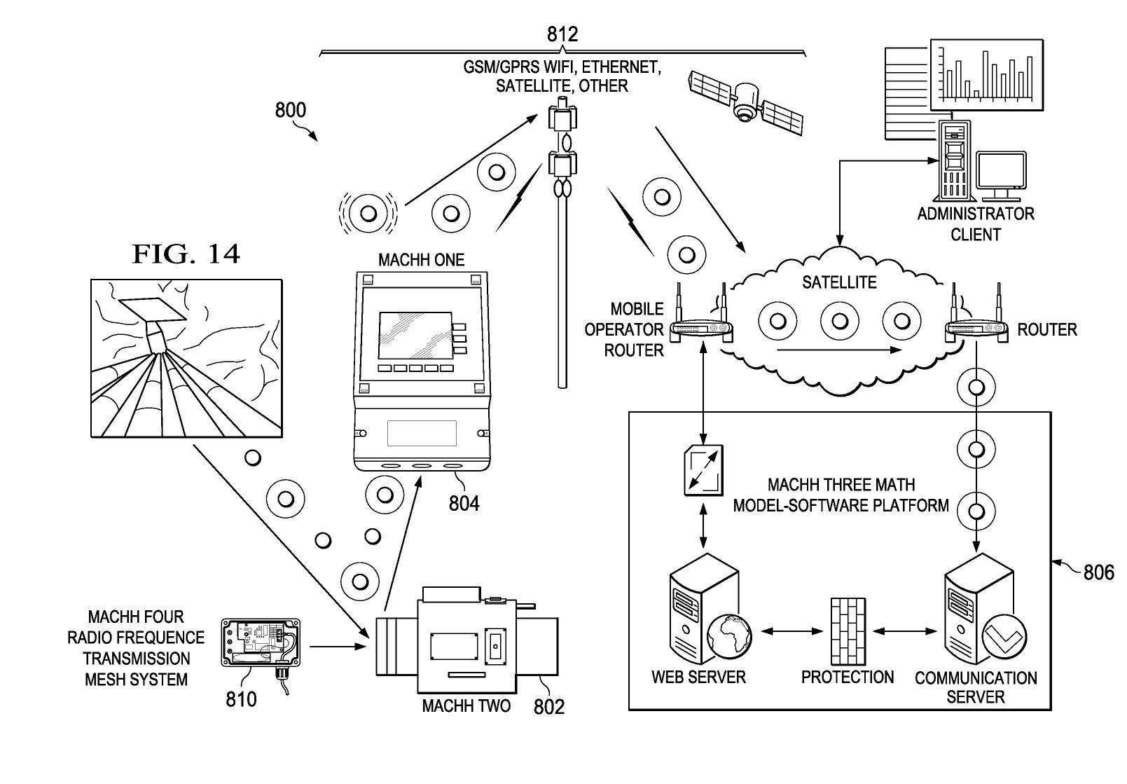

FIG. 14 shows the overall topography of the valve network of the present invention 800 that shows the interconnections between the individual valve units 802 of the valve network, the robot unit M1 804, the intelligent control unit M3 806, the communications unit M4 810, the communications network 812 (cell, wireless, and/or satellite or other electronic communications platform) of the present invention.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context. In certain embodiments, the present invention may also include methods and compositions in which the transition phrase “consisting essentially of” or “consisting of” may also be used.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A valve for connecting to a valve network comprising:
at least one valve assembly, the valve assembly comprising:
at least one valve to control a fluid or gas flow through an opening in the valve assembly;
at least one pressure sensor to detect the pressure of the fluid or gas in the valve assembly;
at least one viscosity sensor to detect the viscosity of the fluid or gas in the valve assembly;
at least one flow rate detector to detect at least one of the flow or the volume of the fluid or gas flowing through the valve assembly;
at least one temperature sensor to detect the temperature of the fluid or gas in the valve assembly;
at least electrical power generator that generates electrical power from fluid flowing through the valve;
at least one processor connected the valve, the pressure sensor, the flow rate detector, the viscosity sensor and the temperature sensor, wherein the processor is capable of controlling the position of the valve based on the information obtained from the pressure sensor, the flow rate detector, the viscosity sensor and the temperature sensor;
at least one communications module connected to the processor capable of transmitting to and receiving information from at least one of other valves in the valve network or a control unit;
at least one security module mounted on the valve and connected to the communications module and the processor, wherein the security module is capable of sending information obtained from the valve assembly to the valve network of the status of the fluid or gas flowing through the valve assembly; and
at least one power source that provides power to the valve assembly, processor and communication module, and the security module and is charged and/or recharged by the electrical power generator.

2. The system of claim 1, wherein the communication modules use at least one of cellular network, satellite network, UMTS network, 2G network, 3G network, GSM network, CDMA network, WCDMA network, GPRS network, iBurst network, WiBro network, WiMAX network, UMTS-TDD network, HSPA network, EVDO network, LTE network, personal area network (PAN), Bluetooth network, ZigBee network, Wireless USB network, or Digital Enhanced Cordless Telecommunications (DECT) network to communicate within the valve network.

3. The system of claim 1, wherein the power source is selected from at least one of a battery, a fuel cell, a power generator, a nuclear power cell, a solar panel, and an electrically connected line across the valve network.

4. The system of claim 1, wherein a secondary communication system is connected to the valve is selected from communication line, a fiber optic line, an intranet, a satellite, a telephone system, and an intranet and has a separate, redundant power supply.

5. The system of claim 1, wherein at least one of the communications module of the valve network is capable of communication with at least one of a remote land-based location or an offshore surface location.

6. The system of claim 1, further comprising a control unit that comprises a secure satellite communications module, a valve control processor, a processor with preconfigured parameters for operating the valve if communications are lost with the valve and one or more webservers that can control additional valves of the valve network.

7. The system of claim 1, wherein the valve is actuated magnetically, electromagnetically, mechanically, electrically, electromechanically, hydraulically, or pneumatically.

8. The system of claim 1, wherein the security modules comprises one or more cameras, motion sensors, or IR sensors, that send information about the physical status of the valve to the valve network.

9. The system of claim 1, wherein the electrical power generator is selected from a solar power cell, an electrical generator, a dynamo, a nuclear power cell, or an alternator.

10. The system of claim 1, wherein the electrical power generator is selected from an electrical generator, a dynamo, or an alternator that transforms kinetic energy into electricity wherein the generator, dynamo or alternator is driven by an impeller, propeller, screw-drive, paddle, or turbine positioned parallel to a fluid flow axis of the valve.

11. A method for use in a pipeline, comprising:
providing two or more valves in a valve network, each valve of the valve network comprising:
at least one valve to control a fluid or gas flow through an opening in the valve assembly, the valve having an open, a partially open and a closed position;
at least one pressure sensor to detect the pressure of the fluid or gas in the valve assembly;
at least one viscosity sensor to detect the viscosity of the fluid or gas in the valve assembly;
at least one flow rate detector to detect at least one of the flow or the volume of the fluid or gas flowing through the valve assembly;
at least one temperature sensor to detect the temperature of the fluid or gas in the valve assembly;
at least electrical power generator that generates electrical power from fluid flowing through the valve;
at least one processor connected to each of the valves, the pressure sensor, the flow rate detector, the viscosity sensor and the temperature sensor, wherein the processor is capable of controlling the position of the valve based on the information obtained from the pressure sensor, the flow rate detector, the viscosity sensor and the temperature sensor;
at least one communications module connected to the processor capable of transmitting to and receiving information from at least one of other valves in the valve network or a control unit;
at least one security module mounted on the valve and connected to the communications module and the processor, wherein the security module is capable of sending information obtained from the valve assembly to the valve network of the status of the fluid or gas flowing through the valve assembly; and
at least one power source that provides power to the valve assembly, processor and communication module, and the security module and is charged and/or recharged by the electrical power generator; and
electronically interconnecting the two or more valves into the valve network in which each of the valves operates, wherein each valve communicates operational data obtained from the pressure sensor, the flow rate detector, the viscosity sensor and the temperature sensor, and the position of the valve to the valve network via the communications module;
wherein the valve assemblies synchronize opening, partially opening and closing of each valves depending on one or more parameters that relate to a fluid flow through each of the valves in the valve network.

12. The method of claim 11, further comprising the step of sharing data across valves or across valves of a pipeline using a wireless network device.

13. The method of claim 11, further comprising the step of storing information in a memory module connected to the processor and transferring the stored information via the valve network.

14. The method of claim 11, further comprising the step of determining if a security breach has occurred along the pipeline by comparing one or more data points obtained from the pressure sensor, the flow rate detector, the viscosity sensor and the temperature sensor, and the position of the valve.

15. The method of claim 11, wherein the valve is open and closed using the wireless network device.

16. The method of claim 11, wherein the communications module operates over a wireless network.

17. The method of claim 11, wherein the communication modules use at least one of GPRS, GSM, RF, WiFi, Ethernet, Zig Bee, or Bluetooth, to communicate within the valve network.

18. The method of claim 11, wherein the power source is selected from at least one of a battery, a fuel cell, a power generator, a nuclear power cell, a solar panel, and an electrically connected line across the valve network.

19. The method of claim 11, wherein a secondary communication system is connected to the valve is selected from communication line, a fiber optic line, an intranet, a satellite, a telephone system, and an intranet.

20. The method of claim 11, wherein at least one of the communications module of the valve network is capable of communication with a remote land-based location and an offshore surface location.

21. The method of claim 11, further comprising a control unit that comprises a secure satellite communications module, a valve control processor, a processor with preconfigured parameters for operating the valve if communications are lost with the valve and one or more webservers that can control additional valves of the valve network.

22. The method of claim 11, wherein the valve is actuated magnetically, electromagnetically, mechanically, electrically, electromechanically, hydraulically, or pneumatically.

23. The method of claim 11, wherein the security modules comprises one or more cameras, motion sensors, or IR sensors, that send information about the physical status of the valve to the valve network.

24. The method of claim 11, wherein the electrical power generator is selected from a solar power cell, an electrical generator, a dynamo, a nuclear power cell, or an alternator.

25. The method of claim 11, wherein the electrical power generator is selected from an electrical generator, a dynamo, or an alternator that transforms kinetic energy into electricity wherein the generator, dynamo or alternator is driven by an impeller, propeller, screw-drive, paddle, or turbine positioned parallel to a fluid flow axis of the valve.

26. A system for interconnecting a valve network on a pipeline, comprising:
a first valve assembly positioned at a first position of the pipeline;
a second valve assembly positioned at a second position of the pipeline;
a central control unit in communication with the first and second valve assemblies, wherein first and second valve assemblies transfer data between the first valve assembly and the second valve assembly using short-range wireless communication operating without the need for a central network.

27. The system of claim 26, wherein the first and second valve assemblies comprise:
two or more valve assemblies, the valve assembly comprising:
at least one valve sensor to control a fluid or gas flow through an opening in the valve assembly;
at least one pressure sensor to detect the pressure of the fluid or gas in the valve assembly;
at least one viscosity sensor to detect the viscosity of the fluid or gas in the valve assembly;
at least one flow rate detector to detect at least one of the flow or the volume of the fluid or gas flowing through the valve assembly;
at least one temperature sensor to detect the temperature of the fluid or gas in the valve assembly;
at least electrical power generator that generates electrical power from fluid flowing through the valve;
at least one processor connected to each of the electromagnetic valve, the pressure sensor, the flow rate detector, the viscosity sensor and the temperature sensor, wherein the processor is capable of controlling the position of the valve based on the information obtained from the pressure sensor, the flow rate detector, the viscosity sensor and the temperature sensor;
at least one communications module connected to the processor capable of transmitting to and receiving information from at least one of other valves in the valve network or a control unit;
at least one security module mounted on the valve and connected to the communications module and the processor, wherein the security module is capable of sending information obtained from the valve assembly to the valve network of the status of the fluid or gas flowing through the valve assembly; and
at least one power source that provides power to the valve assembly, processor and communication module, and the security module and is charged and/or recharged by the electrical power generator.

28. The system of claim 26, wherein the communication modules use at least one of GPRS, GSM, RF, WiFi, Ethernet, Zig Bee, or Bluetooth, to communicate within the valve network.

29. The system of claim 26, wherein the power source is selected from at least one of a battery, a fuel cell, a power generator, a solar panel, and an electrically connected line across the valve network.

30. The system of claim 26, wherein a secondary communication system is connected to the valve is selected from communication line, a fiber optic line, an Internet, a satellite, a telephone system, and an intranet.

31. The system of claim 26, wherein at least one of the communications module of the valve network is capable of communication with a remote land-based location and an offshore surface location.

32. The system of claim 26, further comprising a control unit that comprises a secure satellite communications module, a valve control processor, a processor with preconfigured parameters for operating the valve if communications are lost with the valve and one or more webservers that can control additional valves of the valve network.

33. The system of claim 26, wherein the valve is actuated magnetically, electromagnetically, mechanically, electrically, electromechanically, hydraulically, or pneumatically.

34. The system of claim 26, wherein the security modules comprises one or more cameras, motion sensors, or IR sensors that send information about the physical status of the valve to the valve network.

35. A valve controller for a valve network comprising:
one or more valve control processors that receives input from one or more valve sensors in a valve, wherein the processor comprises one or more preconfigured parameters and adaptive intelligence instructions for operating a valve if communications are lost between the valve and the operator that allows the controller and the valve to act independent of immediate, direct user input,
one or more webservers that can control additional valves of the valve network; and
one or more secure satellite communications modules under the control of the processor capable of communicating with the valves in the valve network and one or more user control centers; and one or more power sources that provides power to the processor, the webservers and the satellite communications module.

36. A valve for connecting to a valve network comprising:
at least one valve assembly, the valve assembly comprising:
at least one valve to control a fluid or gas flow through an opening in the valve assembly;
at least one pressure sensor to detect the pressure of the fluid or gas in the valve assembly;
at least one viscosity sensor to detect the viscosity of the fluid or gas in the valve assembly;
at least one flow rate detector to detect at least one of the flow or the volume of the fluid or gas flowing through the valve assembly;
at least one temperature sensor to detect the temperature of the fluid or gas in the valve assembly;
at least electrical power generator that generates electrical power from fluid flowing through the valve;
at least one processor connected to each of the electromagnetic valve, the pressure sensor, the flow rate detector, the viscosity sensor and the temperature sensor, wherein the processor is capable of controlling the position of the valve based on the information obtained from the pressure sensor, the flow rate detector, the viscosity sensor and the temperature sensor;
at least one communications module connected to the processor capable of transmitting to and receiving information from at least one of other valves in the valve network or a control unit, wherein the secure communications module is capable of sending information obtained from the valve assembly to the valve network about the status of the fluid flowing through the valve assembly; and
at least electrical power generator driven by an impeller, propeller, screw-drive, paddle, or turbine positioned parallel to a fluid flow axis of the valve that provides power to the valve assembly, processor and communication module.
